(19) United States
(12) Patent Application Publication
(10) Pub. No.: US 2007/0099703 A1
(43) Pub. Date: May 3, 2007

(54) Massive role-playing games or other multiplayer games system and method using cellular phone or device

(75) Inventor: Yakir Terebilo, Kiryat (IL)

Correspondence Address: FLEIT KAIN GIBBONS GUTMAN BONGINI & BIANCO, 21355 EAST DIXIE HIGHWAY, SUITE 115, MIAMI, FL, 33180, US

(73) Assignee: IS-INNOVATION SYSTEMS LTD, Ramat Hachayal (IL)

(21) Appl. No.: 10/595,167

(22) PCT Filed: Sep. 14, 2004
(86) PCT No.: PCT/IL04/00841

§ 371 Date: Mar. 15, 2006

Related U.S. Application Data
(60) Provisional application No. 60/502,939, filed on Sep. 16, 2003.

(51) Int. Cl. A63F 9/24; G06F 19/00

(52) U.S. Cl. 463/42; 463/41

(57) ABSTRACT

A massive multiplayer role-playing game platform utilizing mobile devices such as cellular phones is disclosed. The invention links massive amounts of players, each holding at least one mobile device, via a cellular or wireless network. The system provides the user with the game data in a client-server method or in a streaming/buffering mode of operation. Most of the game data is stored on the game servers, and only the minimal amount of data is temporarily stored on the device's memory. The user may play in a single mode or group mode and several groups can join together to make a larger group. A game may be downloaded onto the mobile devices which may be linked to a base station. The base station in turn is connected to the network, which links it to the game server.

### BACKGROUND OF THE INVENTION

1. Field of the Invention

The present invention relates to the field of massive multiplayer wireless games, and more specifically to real time role-playing and other multiplayer games, utilizing mobile phones or PDA devices having cellular or wireless connectivity.

2. Description of Prior Art

The mobile communication world is one of the fastest growing technological fields today. With the feasible technological developments in this field, it will probably maintain this position over then next decade. As developments in this field unfold, it is becoming evident that the mobile handsets—cellular phones and PDA devices—take a more essential part in everyday life. As technology progresses, the mobile phone becomes a useful tool for conducting personal and business communication, allowing the transference of text messages, audio and video information, as well as performing financial transactions. The most apparent trends in this field aims to consolidate all personal and business functions into a single mobile device.

Other evident developments are the rapid improvement in the network infrastructure, which will continue to offer better, faster and more reliable communication capacities. In future, the wireless networks will be able to provide the same facilities given today by the land Internet networks. One of the fastest growing markets in this field is the area of network games. Unfortunately, today there are only three methods for offering game playing via mobile devices. The first are embedded games which are limited by the phone's memory abilities (normally around 60 k), and therefore have poor content, poor graphics and do not store the players' information, such as the users' name, their last completed stage, the players' high score and so on. The second method includes downloaded games, usually Java or Brew based. These games are dependent on the device's memory capabilities and therefore have the same limitation as the embedded games. The third method includes Bluetooth or Infrared networks games, such as the Nokia's Ngage product. These games require at least one user to be the master user, connecting to the wireless network and locally interconnecting the other players. This method is therefore inconvenient since the players are restricted to a limited to the geographic proximity of the master user, and it cannot support multiplier games of massive proportions. Another setback in this method is that the games must be purchased and installed on a game card inserted into the phone. The user's data is only available locally, and is not stored on a game server.

There is therefore a need for a game system method and apparatus that can provide a massive multiplayer game platform, using cellular phones or the mobile PDA devices which connect to a wireless network.

### SUMMARY OF THE INVENTION

A network game system implemented over a wireless data network is disclosed. The system enables real time simultaneous game sessions of multiple players. It is comprised of at least one network server for managing and controlling games sessions, including the core game application wherein parallel sessions of the game are preformed simultaneously and at least two wireless devices having a first transceiver enabling wireless connection to the server (TCP/IP connection, iMode, FOMA, Wi-Fi technologies).

The wireless device may also include a second transceiver enabling short range communication with other wireless devices (Bluetooth, infrared, USB/USB2.0). A game console devices communicates with the wireless devices or is directly connected to the backbone network. The network servers include a players' database which comprises profile data and history data of players' activities.

The network server (or the wireless device) further comprises location base module enabling to identify real location of each user wherein the virtual game location is changed in the relation to the real location. Real entities at predefined locations may also be included wherein interaction with players (such as buying credit) can affect the virtual game activities (such as gaining power) according to pre-defined rules.

The game system also includes a base station and a game server, wherein the cellular network interconnects the base station and the game server, and wherein the mobile phone communicates with the game server via the base station utilizing the first transceiver. The network server may support SMS, email, MMS and video services and the wireless device may include a touch sensitive interface for playing the game and voice operated interface for playing the game.

The system also includes behavior analysis for predicting the user's next moves and providing the user with the respective data in advance for improving the system's performance. In the course of the game users may be divided into groups, each group having a specific IP range. The system may also use HSDPA (High speed Downlink Packet Access) technology.

The game system may enable players to talk on the phone while playing the game—Multi Access allows subscribers to communicate by voice while simultaneously using packet transmissions.

The system enables players to create communities based on game activities. The wireless device may include display screen including touch screen or 3D imaging, speaker, a microphone and a camera.

The system enables the game to continue uninterrupted, while at least one user is in offline mode enabling the user to return to online mode at any time and to continue the game with no effect on user's or other players' game experience. The system provides the users with information status of other players.

One device may be selected by the server enabling it to function as mirror of the server for a specific group of players, allocating this device the highest priority. This device distributes the commands of the main server to all group members. The role of the selected device may be switched by the system between the devices of different users randomly or using a round-robin technique.

The server may postpone the delivery of user command for a short interval of time until receiving commands from the other players, processes it, and distributes the result of the respective actions simultaneously to all the players. The server may send only the changes in the display of the screen from the last action of the game.

The system may Implement Artificial Intelligence (AI) technology into the game for anticipating at least one user's next move, enabling preloading of data in accordance with user expected move.

The server may use the processing power of the local mobile device for the purpose of processing data. The system may include stationary game interfaces; user using said interface are enable to participate within the network game.

### DESCRIPTION OF THE DRAWINGS

FIG. 1 is a schematic illustration of the system.

FIG. 2 is a schematic illustration of a possible embodiment for incorporating short haul connectivity in the system.

FIG. 3 is a block diagram of the system's preferred embodiment of the game servers' layout.

FIG. 4 is an illustration of an output display having eight slices.

FIG. 5 is an illustration of different input methods of the mobile device.

### DETAILED DESCRIPTION OF THE INVENTION

In the following description of the embodiment, reference is made to the accompanying drawings which form a part hereof, and in which is shown by way of illustration the specific embodiment in which the invention may be practiced. It is to be understood that other embodiments may be utilized as structural changes may be made without departing from the scope of the present invention.

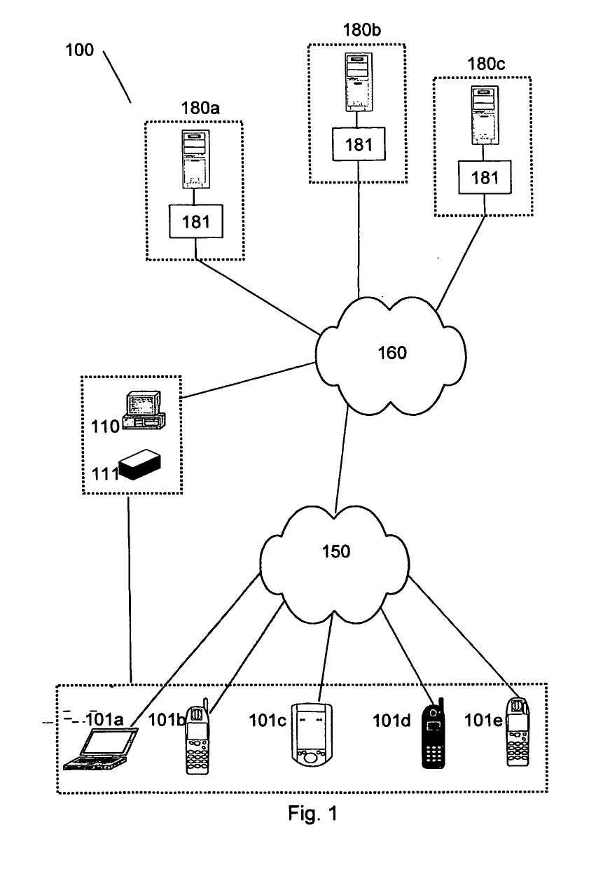

FIG. 1 portrays system 400 for multiplayer and massive multiplayer games. The system allows players to take part in multiplayer games, using mobile device 401 that includes game controllers and a display terminal. The mobile devices 401 connects individually to a game server 480 over a wireless data network 450 and data transmission network 460. The game server 480 processes the player's input data from the device's controllers 401, generates game images and transmits them back to the player's device 401, via data networks 450, 460, which can then be viewed by the players. The mobile devices can also connect to stationary game machines, such as a PC's 410 or a game console 411 (such as a PS or a XBOX) through short range communication or via the networks 450, 460.

In order to transfer the player's input data to server 480, data connections are established through wireless network 450 between the devices 401 and the game server 480. The method of establishing the data connection between the server 480 and the device 401 depends on the type of technology of device 401, the wireless data network 450, the transmission network 460 and the server 480 implemented in the said system 400.

In a mobile handset embodiment, devices 401 may transmit dual-tone multi-frequency (DTMF) signals through a voice phone wireless network 450 and network 460 to a telephone network interface 481 in the game server 480. Players can control the game using the phone's numeric keypad, the phone's joystick or touch screen. In some embodiments, the game server 480 may also receive voice commands from the players by means of their telephone handsets 401. Other embodiments can include devices 401 that communicate by sending data over networks 450, 460. Interface between networks 450, 460 can then be a digital subscriber line which connects to a packet-based digital network 460, such as an Internet, Ethernet, Wi-Fi or wireless telephone digital data channel network. Another possible embodiment of the networks 450, 460 interfaces may be a packet adjuster such as iMode or FOMA networks.

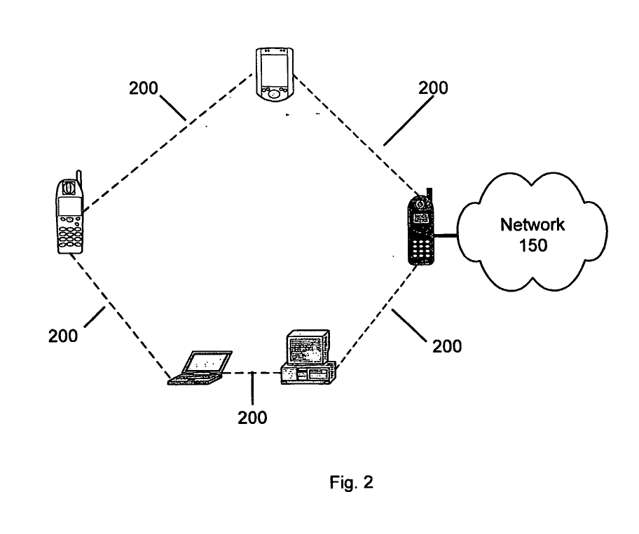

Data derived from player by devices 401 is sent through the wireless network 450 to network 460, and then to a player data interface 481 on the game server 480. Different types of data interfaces 481 may be used, depending on the controllers of devices 401 and the wireless network 450 technology used in the system 400. FIG. 2 illustrates alternative methods of implementing short-haul communication 550 between devices. Such methods may include TCP/IP connection, Bluetooth, infrared, USB/USB2.0, Firewire or Wi-Fi technologies.

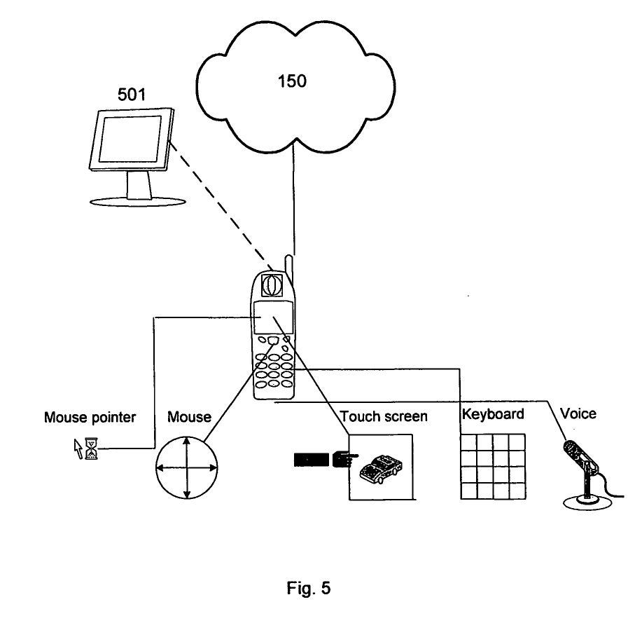

In a packet-based network 450 embodiment, the data connection may be established using a network address for interface 481 in the data frame header sent from network 460. Since communication between the game interface 481 and the network 460 is based on the TCP/IP protocol the system may waive initiating a verification signal each time that a data packet arrives, since TCP/IP protocol accounts for that. Having established a data connection, the input data of the player is associated with a game server 480 and is routed there by interface 481. It is possible to use multiple game servers 480 or a single one. In the multiple server embodiment the servers 480a, 480b, 480c are working in parallel, so the users are not associated with any specific server. As described below, each game server 480 runs the game instructions and receives player input data from any of the participants of the particular game. This packet implementation can be modified to suit iMode, FOMA or any other methods of packet communication networks. If a server 480 offers multiple game types, players may select their desired game before the player's input data is associated with a particular game server 480. Game type selection may be controlled by a designated display on terminal 401. The display can indicate that a numeric code should be entered, or that a joystick or any other controller should be used to select a game type, as shown in FIG. 5. The player's display 401 may indicate, for example, that a joystick should be moved up to play a war type game, left to play chess and right to play a role-playing game. In the case of a single game type server 480, selection of the game type is chosen by default. FIG. 5 also illustrates an embodiment which includes the possibility of transmitting the game's display onto a larger display interface, such as a computer screen 701.

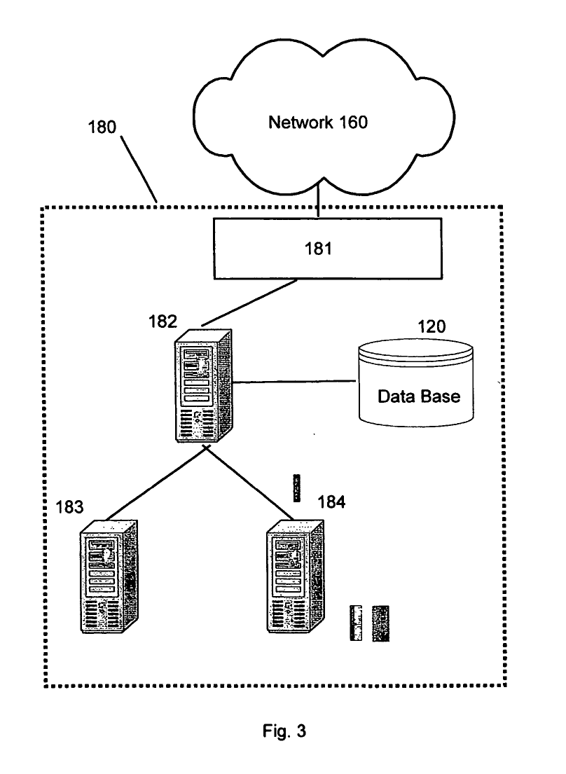

Once the type of game has been selected by the player or by default, the player will be assigned to a game server 480. As illustrated in FIG. 3 the game server's system 480 is a system constructed of servers 482, 483, 484 which are linked to each other, where every server 482, 483, 484 may serve a different purpose. A purpose of Server 482, 483, 484 may relate to locating the real-world position of a player, connecting to an email, SMS, a voice, a MMS or a video server. Some of the servers 482, 483, 484 may carry out functions such as billing, reporting, enabling chat utilities between different users or monitoring. Some servers 482 operate the kernel of the application, and connect to the 420 Data Base, as described in FIG. 2.

Database 420 may contain records identifying players, their input data connection method, their game profile, scores, friends, the group they belong to, their credit and other types of information. The kernel server 482 then loads player's information when the player selects the game. Players may be required to be identified by system 480 login information, using a username and password, a received telephone number (e.g., via caller-ID functionality), a network address, a portal authentication or by any other network 450, 460 connection means of identification. Once the player was authenticated, the server 482 loads the information of the user's group, and lets him know which other group members are online and their specific location.

The user may also create a group of a single player. The system 400 allows merging different groups into a single group. The server 480 also notifies other group members in his group that the player has logged in, and can be located in a specific position. If the group's game is in progress, the user simply joins the game session. In a single mode, the player restores the game from the point he last stopped. Once online, the player he can communicate with other group members via SMS, voice, MMS, video, email, chat or any other means of communication supported by their devices 401. Both in individual and in group modes, players are automatically assigned to tasks matching their skills according to prior stages of the game, and will be matched with opponents with similar skills. Having completed the given task, the user accumulates credit points which enable him to continue to more advanced tasks. Real-world entities at predefined location may interact with player (such as buying credit) and can affect the virtual game activities (such as gaining power) according to pre-defined rules. The user may also download credit points from the network.

A locating component on server 480, integrating cellular service provider positioning information, or a GPS component in device 401 may give the real-world position of the player. This may be integrated into the game by building virtual space over the real-world surroundings, wherein places in the real word have parallel location in the virtual space. If the user playing a problem solving game is located in a shopping center, for example, the system 400 may portray him as a detective, and the shopping center as a crime scene, and have the player collect evidence in these surroundings.

Having established the connection with the game servers 480, the player's input data is routed from the networks 450, 460 through a game server interface 481 to the relevant game servers 480. The game server interface 481 translates the player input data from the controllers 401 into a game server 480 compatible format by hardware or by software means. Formatting the player input data will depend on the game server 480 implementation. Each game server 480 may contain a separate software process executing on a single multi-tasking computer system. The game engines 482, 483, 484, for example, may contain software processes executed on a server 480 running a Windows server, UNIX or Linux operating system. Game server interface 481 may be a software implemented application programming interfaces, which is compatible to a phone system technology, such as J2me, Brew, MS Smartphone/Mobile, Linux and Symbian.

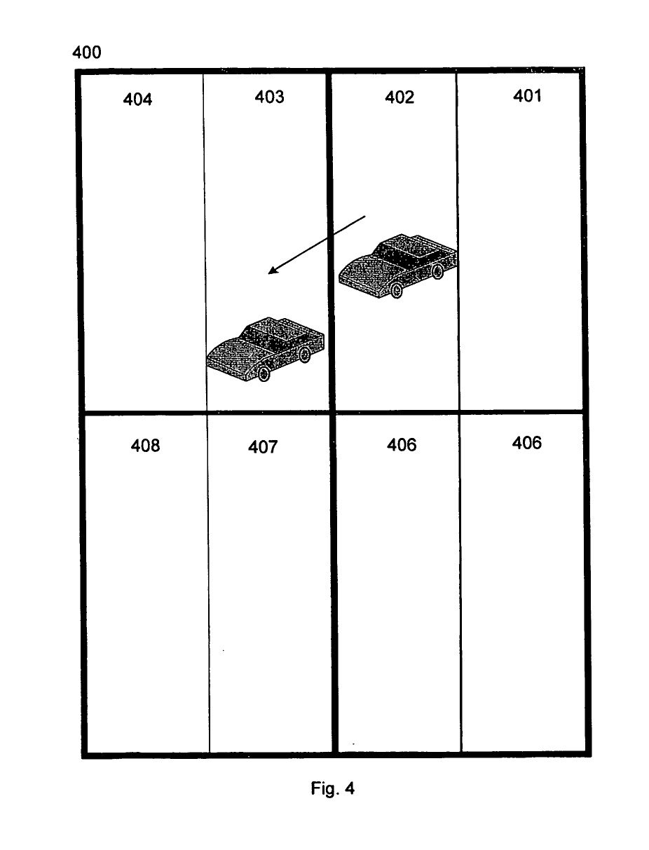

Different areas of the generated video output display image may be associated with different players of a multiplayer game. FIG. 4 illustrates an example for an output display 600. The screen output image 600 can be divided into eight equal slices. Any change in the game that is sent from the server will be tagged with the relevant slice. The server sends only the changes in the display of the screen from the last act. The screen can be sent in a modified HTML, video, rendering graphics or other visual data formats and translated by the wireless device to a screen images. In a car game, the car moves from slice 602 to slice 603.

Following is the description of the real time implementation. Since the network transfer rates are high, and they are improving rapidly, and since data traffic will be more reliable and there will be less lost of information in real time, this system can be embodied in real time voice technology. This is made possible by the fact that in advanced wireless networks every subscriber is always online and has his own “virtual channel” in the network. The system 400 leverages these advantages. Working in full duplex with the wireless data network 450 and the data server 480, the phone 401 will receive and transmit game data and other data from and to the network 450 and game server. Implementing Artificial Intelligence (AI) technology into the game could create a real time effect. This will allow the game to anticipate the user's next move. For example, if a player has two possible moves, and one of them is better then the other the server could expect the user to choose the better option. This improves performance and would appear as real time response from the user's point of view. This method could be interwoven throughout the application. Some other implementation of AI may learn the user's profile of playing behavior and anticipate the next moves.

Since some functions are done repeatedly throughout the game and therefore it is useless to use the network for controlling such functions, the application may use the processing power of the local mobile device and send the results to the network. This will also enable real time.

The streaming/buffering method used by the system 400 may give performance, which is close to real time. The system may also use a compressed data method for better efficiency, a graphical accelerator and other chips within the mobile device for the same purpose.

When dividing the game into groups by the game interface every group may be allocated with a specific IP range (subnet). This creates a more networked efficient game and enables real time performance.

The game server may work in a listening-executing mode. Hence, whenever two players are engaged in a game, for example, as soon as one of the players sends a command, the server will identify this command and distribute it to the other player. The “first in and smallest packet” will be the first out. Then, if both players send command at the same time, the one with the easier to execute command will be complete first.

Another method of implementation may be done via the game interface, by selecting a leader for example. In this method the leader is the group's representative.

In another method of implementation one user sends a command, the server waits for a short interval for a command from other players, processes it and distributes the result of both actions to the players.

Another method of implementation is that within a specific group of players, one device is “chosen” by the system to be the main client and it is allocated the highest priority. Hence, the main client acts as a replica of the main system's server, serving all the devices within this group and is the only device which is actually connected to the main server/s of the system.

When an action is taken in the game, the main client processes it and sends results to all group members and to the server. It may also the first to send the data to the server, wait for reply, and then distribute it to all other clients.

The server can choose one main client, or switch between main clients randomly, in a round-robin method or in any other method. The main client does not necessarily have to be a part of the group; it may still act as the server for the group. The main client does not necessarily have to be an active player in the game. The system may also create groups of main clients which in turn have a main client controlling them or simply have more than one main client for a single group.

The term “game” may encompass games or role-playing games and other forms of computer implemented recreational or professional application. Such implementation may include war or battle simulation, leadership testing games, educational application with questions as obstacles, learning about consumers' response toward a product or service, simulating on site troubleshooting for field engineers or any other application which demands sending images to the device's 401 screen according to a predefined algorithm.

The term “player” may include any human or machine user that participates in the recreational or professional application program. As described herein, different digital sampling rates and digital sampling combined with compression technologies may also be used for transmission of analog or voice signals. The term “mobile network” includes both traditional wireless networks such as GSM, CDMA, TDMA, 3 G networks such as UMTS/W-CDMA, CDMA-2000, TD-CDMA, IS-95 or other 3 G implantation, and other cellular and wireless networks such as 4 G and beyond. The system may also use High speed Downlink Packet Access (HSDPA) technology. It may also include networks based on Wi-Fi or similar networks. Data and packet data networks include landline networks, the Internet, Wi-Fi, wireless data networks, digital traffic and signal channels used in cellular phone networks. The present invention provides A game system, comprising: a mobile phone/device which is the game interface having a first transceiver providing connections to a cellular network and may have a second wireless transceiver for phone to phone short-range wireless communication (Bluetooth, Infrared, Wi-Fi) or phone to PC wired connection (USB).

The game system stores all user data on the game server database. The user data may contain such details as the player's, profile last achieved level, group, friends, score, last known location, user's game, chat rooms, preferences and playing habits. The database can also store scenes from the game and replay them on demand.

The game system may comprise wireless short range transceivers which include modules designed according to Bluetooth specification, infrared transceivers, universal asynchronous interface (UARTs or a CE-BUS), Wi-Fi specification.

The system is comprised of a provisioning layer for minimizing errors on delivery/receiving information and for a better quality of service. The system is also comprised of an intermediating layer which prevents undesired communication such as a “virus” attack. A component which interacts with operator's operation and maintenance (O&M) tools such as Simple Network Management Protocol (SNMP) may also be integrated in the system.

The system may operate in different transfer modes such as Symmetric Transfer Mode, ATM, IP over ATM. It may also have the ability to work on both circuit and packet switched networks, communicating with Mobile Satellite Systems (such as IRIDIUM), or in different Wideband Code-Division Multiple Access (WCDMA) methods such as frequency division duplex (FDD) and time division duplex (TDD).

The system can connect to the operator's portal and to the operator's Lightweight Directory Access Protocol (LDAP) server for actions such as loading the user's profile. On the client side the system may connect to the contact list of the end users and applications such as PIM managers.

The systems may interconnect to home entertainment products (for example: a TV to present the game on a bigger screen).

The game system wherein for wired connection the USB/Firewire specification is used.

The game system transceivers can be enabled to download the game onto a mobile unit.

The mobile phone/device (PDA) according to the present invention is comprised of:
A keypad and/or a joystick for providing user input; the system may use the multi key function. The system may provide the user with the ability to re-deploy the relevant keys at wish:
A speaker and microphone for providing audio data to a user and receiving data from the user;
A display screen for displaying information concerning the mobile phone and the application to a user, the screen may be a touch screen; the screen may utilize a technology of 3D imaging or the application may provide a 3D solution.
A first transceiver for providing connections to a cellular network;
A second wireless transceiver for bypassing the cellular network to provide wireless interactive gaming connectivity; and
A controller, coupling the keypad, speaker, microphone, display and first and second transceivers, for processing data.
A converter application such as Windows Media Player or Real Player that displays still, video and sound data (or a combination of the three) on the phone/mobile device.
It may use a built in camera (rotating) for capturing pictures or video for messaging or video calls—the system will integrate these in the game.
It may use an USB/Firewire connection in order to connect to a PC for downloading the game.
The phone may have a vibrating battery. If so, it will be integrated in the game for enhanced game experience.

The game method according to the present invention comprise the steps of:
Displaying a game on a plurality of game units;
Linking the plurality of game phones/devices to the cellular network using a transceiver; and
Sending game signals from the mobile device/phone to a game server for processing.

The game system according to the present invention may allow players to talk on the phone while playing the game—Multi-access allows subscribers to communicate by voice while simultaneously using packet transmissions.

High network connection will enable the game to be real time. Therefore the game will not have to be a turn-based game and all players could play simultaneously. The system can also utilize a number of channels like nx64 kbps or higher.

The system may allow players to chat one with another, send SMS, MMS and Video messages and sound while playing and will integrate them as part of the game.

The system can use either streaming/buffering method or client-server method.

The system will allow users to be identified not only by a specific phone number as their subscription base, hence allowing the user to play from different devices.

The system will use a secure channel to ensure that the client's privacy will not be harmed.

The system may integrate an external location server with the application for uses such as: a) identifying enemies/friends/groups near the player. b) converting the reality into the game's reality, hence building screens of the virtual reality—(the application) according the locations in reality.

The system will allow downloading credit from the network, other players, stations (e.g.: shops) in order to confront game obstacles.

The system will enable to provide an online expert advice from experienced players of the system.

The system may treat the client's screen as divided into several equal smaller screens (e.g. six equal screens) mapped by coordinates and will send only the information that has changes to the relevant sub-screen.

Subject to global roaming agreements the client could use the service when visiting another network and subject to network agreements clients from different networks could compete on the same game.

In some implementations, the system will use the MIDP, technology, CLDC, XML, Java smart cards, or any technology that will enable socket connection from the phone.

In some implementations the systems will use a technology that will provide the mobile phone an IP address (the system is compliant to ipv4/ipv6 and onward).

The system will create communities with common interests based on the game and/or the user's profile.

In some implementations, the systems will use the end user terminal processing power to process the user activity and then distribute the result to the rest of the network.

The game system of the present invention is enabled to work at a continuous mode, allowing a user to go “offline” without interrupting the course of the game. Once the user chooses to return “online”, the user can continue the game with no effect on users or other players' game experience (this could be performed by, for example using the “always on” ability of 3 G networks). The game system informs the users who of the players is “online” and who is “offline” at any given moment. The game type to be used for the above described platform are not limited for cellular based games, any electronic games which are known in the art for PC devices can be transformed and adapted for cellular game platform of the present invention maintaining the original game logic.

A number of embodiments of the present invention have been described. Nevertheless, it will be understood that various modifications may be made without departing from the spirit and scope of the invention. For example, when a data is sent from the server to the terminal it can be decoded by using a video audio decoder such as Windows Media Player or Real player or other decoders in real time or buffering/streaming mode. Accordingly, other embodiments are within the scope of the following claims. While the above description contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. A network game system implemented over a wireless data network, enabling real time simultaneous game sessions of multiple players, said system comprised of:
At least one network server for managing and controlling games sessions, including the core game application wherein parallel sessions of the game are preformed simultaneously;
At least two wireless devices having a first transceiver enabling wireless connection to the server (TCP/IP connection, iMode, FOMA, Wi-Fi technologies).

2. The system of claim 1 wherein the wireless device further includes a second transceiver enabling short range communication with other wireless devices (Bluetooth, infrared, USB/USB2.0).

3. The system of claim 2 further comprising game console devices communicating with the wireless devices or directly connected to the backbone network.

4. The system of claim 1 wherein the network servers include a players' database which comprises profile data and history data of players' activities.

5. The system of claim 1 wherein the network server (or the wireless device) further comprises location base module enabling to identify real location of each user wherein the virtual game location is changed in the relation to the real location.

6. The system of claim 2 further comprising real entities at predefined locations wherein said interaction with player (such as buying credit) can affect the virtual game activities (such as gaining power) according to pre-defined rules.

7. The game system of claim 1 further comprising a base station, and a game server, wherein the cellular network interconnects the base station and the game server, and wherein the mobile phone communicates with the game server via the base station utilizing the first transceiver.

8. The game system of claim 1 wherein the network server may support one of the following services: SMS, email, MMS, video.

9. The game system of claim 1 wherein the system further includes behavior analysis for predicting the user's next moves and providing the user with the respective data in advance for improving the system's performance.

10. The game system of claim 1 wherein the users are divided into groups, each group having a specific IP range.

11. The game system of claim 1 may also use HSDPA (High speed Downlink Packet Access) technology.

12. The game system of claim 1 further enabling players to talk on the phone while playing the game—Multi-access allows subscribers to communicate by voice while simultaneously using packet transmissions.

13. The game system of claim 1 further enabling players to create communities based on game activities.

14. The game system of claim 1 wherein the wireless device includes a touch sensitive interface for playing the game.

15. The game system of claim 1 wherein the wireless device includes voice operated interface for playing the game.

16. The game system of claim 1 wherein the wireless device includes display screen including one of the following technologies: touch screen or 3D imaging.

17. The game system of claim 1 wherein the wireless device includes a speaker and microphone.

18. The game system of claim 1 wherein the wireless device includes a camera.

19. The game system of claim 1 wherein the game continues uninterrupted, while at least one user is in offline mode enabling the user to return to online mode at any time and to continue the game with no effect on user's or other players' game experience

20. The game system of claim 17 wherein the system provides the users with information status of other players.

21. The game system of claim 1 wherein at least one device is selected by the server enabling said device to function as mirror of the server for a specific group of players, allocating said device the highest priority.

22. The system of claim 21 wherein said device distributes the commands of the main server to all group members.

23. The system of claim 21 wherein the server switches the role of the selected device between the devices of different users using a round-robin technique.

24. The system of claim 21 wherein the server switches the role of the selected device between the devices of different users randomly.

25. The system of claim 1 wherein server postpones the delivery of user command for a short interval of time until receiving commands from the other players, processes it, and distributes the result of the respective actions simultaneously to all the players.

26. The system of claim 1 wherein the server sends only the changes in the display of the screen from the last action of the game

27. The system of claim 1 further Implementing Artificial Intelligence (AI) technology into the game for anticipating at least one user's next move, enabling preloading of data in accordance with user expected move.

28. The system of claim 1 wherein the server uses the processing power of the local mobile device for processing data.

29. The system of claim 1 further comprising stationary game interfaces, wherein user using said interface are enable to participate within the network game.
